(19) United States
(12) Patent Application Publication
(10) Pub. No.: US 2019/0122152 A1
(43) Pub. Date: Apr. 25, 2019

(54) COLLABORATIVE CONTENT CREATION SYSTEM

(71) Applicant: Sony Interactive Entertainment LLC, San Mateo, CA (US)

(72) Inventors: Charles McCoy, San Mateo, CA (US); True Xiong, San Mateo, CA (US); Nathan Blaine Morgan, San Mateo, CA (US); Christopher McEniry, San Mateo, CA (US)

(21) Appl. No.: 15/793,707

(22) Filed: Oct. 25, 2017

(51) Int. Cl. G06Q 10/06; H04L 9/06; G06F 3/048; G06F 15/18; G06F 8/71

(52) U.S. Cl. CPC G06Q 10/06313; G06Q 10/0639; H04L 9/0637; G06T 13/20; G06F 15/18; G06F 8/71; G06F 3/048

(57) ABSTRACT

A system in which people with different skills collaboratively work together build creative content each by contributing the type of work that he or she is best at. Four modules of the system include the specialization of contributions, in which creators make types of contributions depending on their strengths and interests, content curation and distribution for evaluating content and controlling the bundling and distribution of content, workflow/tracking that keeps an immutable history of work and allows branching, and compensation for contributors that tracks the contributions made by each creator and determines compensation based on the amount and/or perceived quality or worth of work each creator puts into the creation of content.

### FIELD

The present application relates to technically inventive, non-routine solutions that are necessarily rooted in computer technology and that produce concrete technical improvements,

### BACKGROUND

Content such as for computer games typically has a number of contributors. For example, one content creator may provide images of weapons, one might provide images of people, one might provide a story line, one might provide sound selection, etc. As understood herein, it is desirable to compensate content creators based on the value of their contributions to a piece of content such as a computer game.

### SUMMARY

Accordingly, a system includes a processor-implemented contribution module to which creators make types of contributions to content depending on their strengths and interests. The system also includes a processor-implemented content curation and distribution module for evaluating content from the contribution module and controlling bundling and distribution of content, and a processor-implemented workflow/tracking module that facilitates branching and. combining content from the content curation and distribution module. The system still further includes a processor-implemented compensation module that tracks contributions to the contribution module made by each creator and determines compensation based on an amount and/or perceived quality or worth of work each creator puts into creating the content.

In examples, the content includes a computer game. The contributors contribute content pieces in source code, and the system modules can be embodied by one or more compiler programs that are executed by one or more processors to execute logic of the modules.

In non-limiting implementations, the contribution module includes input for receiving contributions in at least re of: drawing artwork, writing text descriptions/naming characters, story writing/history or backstory creation, game mechanics including rules and strategy authoring, software programming, animation, sound effects, music scoring, performing, recording, and mixing, play-testing, user interface (UI) design, and graphic design, and high-level project direction. The contribution module may include a map indicating that certain types of first content pieces should go in particular locations of a final content product and those first content pieces are created later, while existing second content pieces are placed in the final content product as the map is created.

In some embodiments, the content curation and distribution module may include a first sub-module to weed out first content and promote second content. The content curation and distribution module may also include a second sub-module to determine appropriateness of content pieces for an environment in which the content pieces are sought to be used. The second sub-module may be configured to ensure that a style of artwork is consistent with a range of artwork styles already in a computer game. Still further, the content curation and distribution module may include a third sub-module for testing of the content pieces and a fourth sub-module to receive end user input into content that is included in public distributions. Further still, the content curation and distribution module can include a fifth sub-module to group content pieces into expansions that are evaluated and distributed by curators as a group of content and a sixth sub-module to rate content pieces based on fitness for cultural values. Content from the contribution module an be agnostic to any game engine, and the content curation and distribution module can include a seventh sub-module to customize content for particular game engines. An eighth sub-module may be provided to receive input from consumers regarding content that consumers desire to have.

In examples, the workflow tracking module can include a first sub-module to store content from the contribution module and maintain a process history and allow branching. The workflow/tracking module may use block chain technology for tracking contributions and may include a second sub-module to facilitate branching of content to create alternate versions of the content.

In another aspect, a system includes a processor-implemented compensation module that tracks contributions of content pieces made by plural creators and determines compensation based on an amount and/or perceived quality or worth of work each creator puts into creating the content pieces. The compensation module includes a first sub-module to accord creators work credit for the amount of time they put into their respective content pieces. That is, while the amount of time a creator put into content piece may not be measured, compensation can be based on the type and style of work so that work that tends to be more time consuming to create can be valued more for compensation purposes as a way aligning the compensation level with the level of effort by creators. in some implementations time, spent play-testing could translate into units of work contribution.

The compensation module may also include a second sub-module to prorate the work credit to reflect a percent of the content piece relative to the work on final content that is published. Also, a third sub-module adjusts total amount of credit for a piece of content based on an amount that the piece of content is used in the final content. Moreover, a fourth sub-module establishes a form of compensation to content creators. A fifth sub-module may further adjust compensation based on feedback on the use of the content to increase the portion of compensation to contributors of pieces that are favored or used more by end users.

In another aspect, a method includes receiving requests from plural sources for content creation, and creating content based on the requests. The method includes curating and distributing the content in a multi-tier distribution chain, storing the content to allow access to the content by consumers for consumption, and determining popularity or success of individual content titles. Based on the popularity of success of individual content titles, creators of content pieces in the individual content titles are remunerated.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram illustrating the four primary modules of an example consistent with present principles;

FIG. 3 is a block diagram of an example processor-implemented specialization of contribution module;

FIG. 4 is a block diagram of an example processor-implemented content creation and distribution module;

FIG. 5 is a block diagram of an example processor-implemented workflow/tracking module;

FIG. 6 is a block diagram of an example processor-implemented compensation for contributors module;

FIG. 7 is a block diagram of an overall specific architecture; and

FIG. 8 is a flow chart of an example flow of work,

### DETAILED DESCRIPTION

This disclosure relates generally to computer ecosystems including aspects of consumer electronics (CE) device networks such as but not limited to computer game networks. A system herein may include server and client components, connected over a network such that data may be exchanged between the client and server components. The client components may include one or more computing devices including game consoles such as Sony PlayStation® or a game console made by Microsoft or Nintendo or other manufacturer virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a hard disk drive, CD ROM or Flash drive. The software code instructions may also be downloaded over the Internet.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of B, or C” and “a system having at least one of A, B, C”) includes systems that have A alone, B alone, C alone, A and B together, A and C together, B and C together, and/or A, B, and C together, etc.

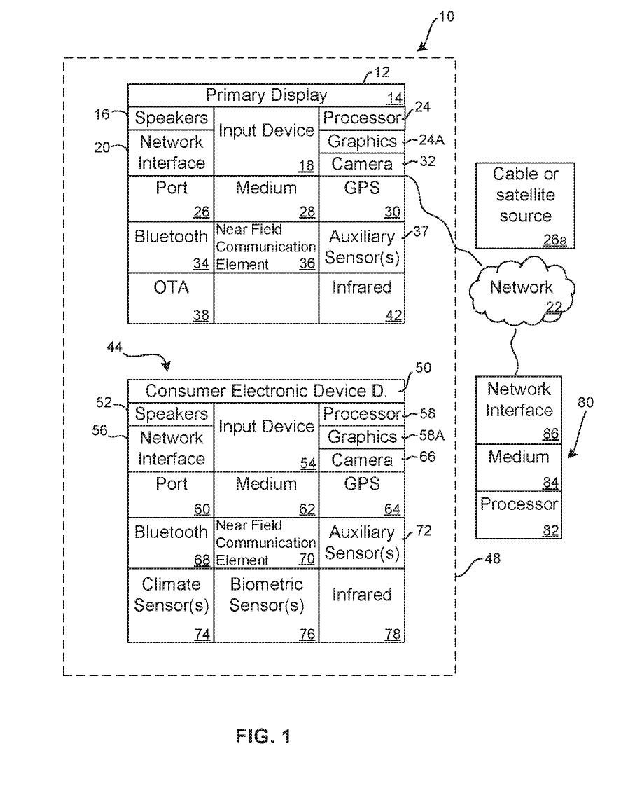

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). However, the AVD 12 alternatively may be an appliance or household item, e.g. computerized. Internet enabled refrigerator, washer, or dryer. The AVD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g. communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as e.g. an audio receiver/microphone for e.g. entering audible commands to the AVD 12 to control the AVD 12. The example AVD 12 may also include one or more network interfaces 20 for communication over at least one network 22 such as the Internet, an WAN, an LAN, etc. under control of one or more processors 24. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as a graphics processor 24a for controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVD 12 may also include one or more input ports 26 such as, e.g., a high definition multimedia interface (HDMI) port or a USB port to physically connect (e.g. using a wired connection) to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content such as computer game software and databases. The source 26a when implemented as a game console may include some or all of the components described below in relation to the CE device 44.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVD 12 is disposed in conjunction with the processor 24. However, it is to be understood that another suitable position receiver other than a cellphone receiver, GPS receiver and/or altimeter may be used in accordance with present principles to e.g. determine the location of the AVD 12 in e.g. all three dimensions.

Continuing the description of the AVD 12, in some embodiments the AVD 12 may include one or more cameras 32 that may be, e.g., a thermal imaging camera, a digital camera such as a webcam, and/or a camera integrated into the AVD 12 and controllable by the processor 24 to gather pictures/images and/or video in accordance with present principles. Any of the cameras described herein may employ the high spectrum camera example or multiple examples described further below.

Also included on the AVD 12 may be a Bluetooth transceiver 34 and other Near Field Communication (NFC) element 36 for communication with other devices using Bluetooth and/or NEC technology, respectively. An example NEC element can be a radio frequency identification (RFID) element. Zigbee also may be used.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12.

Still referring to FIG. 1, in addition to the AVD 12, the system 10 may include one or more other CE device types. In one example, a first CE device 44 may be used to send computer game audio and video to the AVD 12 via commands sent directly to the AVD 12 and/or through the below-described server while a second CE device such as the source 26a may include similar components as the first CE device 44. In the example shown, CE device may be configured as a VR headset worn by a player or a hand-held game controller manipulated by the player. In the example shown, fewer or greater devices may be used.

In the example shown, to illustrate present principles the devices are assumed to be members of an entertainment network in, e.g., a home, or at least to be present in proximity to each other in a location such as a house. However, present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer or game controller (also referred to as “console”), and accordingly may have one or more of the components described below. The first CE device 44 may be a remote control (RC) for, e.g., issuing AV play and pause commands to the AVD 12, or it may be a more sophisticated device such as a tablet computer, a game controller communicating via wired or wireless link with the AVD 12, a personal computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. A graphics processor 58A may also be included. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modern or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid-state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NTC) element 70 for communication with other devices using Bluetooth and/or NEC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. The CE device 44 may communicate with the AVD 12 through any of the above-described communication modes and related components.

A CE device may include some or all of the components shown for the CE device 44. CE devices may be powered by one or more batteries.

Now in reference to the afore-mentioned at least one server 80, it includes at least one server processor 82, at least one tangible computer readable storage medium 84 such as disk-based or solid-state storage, and at least one network interface 86 that, under control of the serve processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver,

Accordingly, in some embodiments the server 80 may be an Internet server or an entire server “farm”, and may include and perform “cloud” functions such that the devices of the system 10 may access a “cloud” environment via the server 80 in example embodiments for, e.g., network gaming applications. Or, the server 80 may be implemented by one or more game consoles or other computers in the same room as the other devices shown in FIG. 1 or nearby.

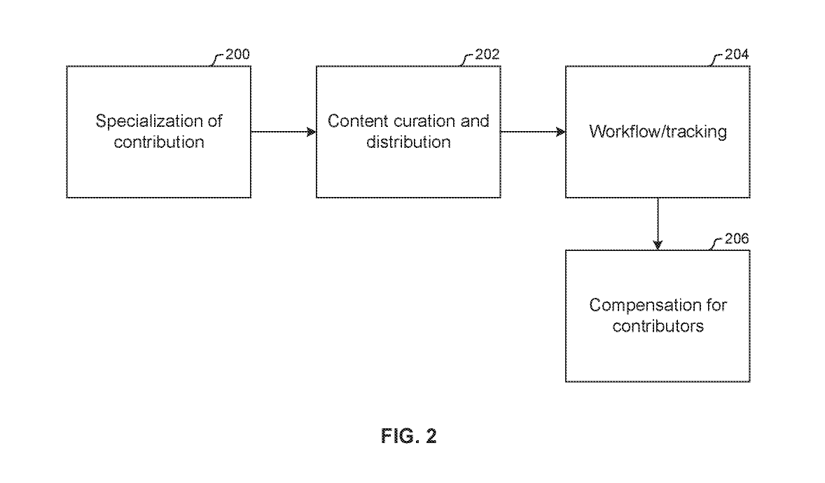

FIG. 2 illustrates that in an example, four overall modules are provided each of which is described in fuller detail below, including a specialization of contribution modules 200 to enable different users to make different types of contributions depending on their strengths and interests. Also, a content curation and distribution module 202 enables curation and distribution of the content from the specialization of contribution module 200, and a workflow/tracking module 204 tracks the distribution of content from the curation and distribution module 202. Also, a compensation for contributors module 206 allocates compensation among the creators of the content. In some implementations, there is no compensation module 206. In such implementations, the contributors may still be tracked so that attribution can be given to the content creators.

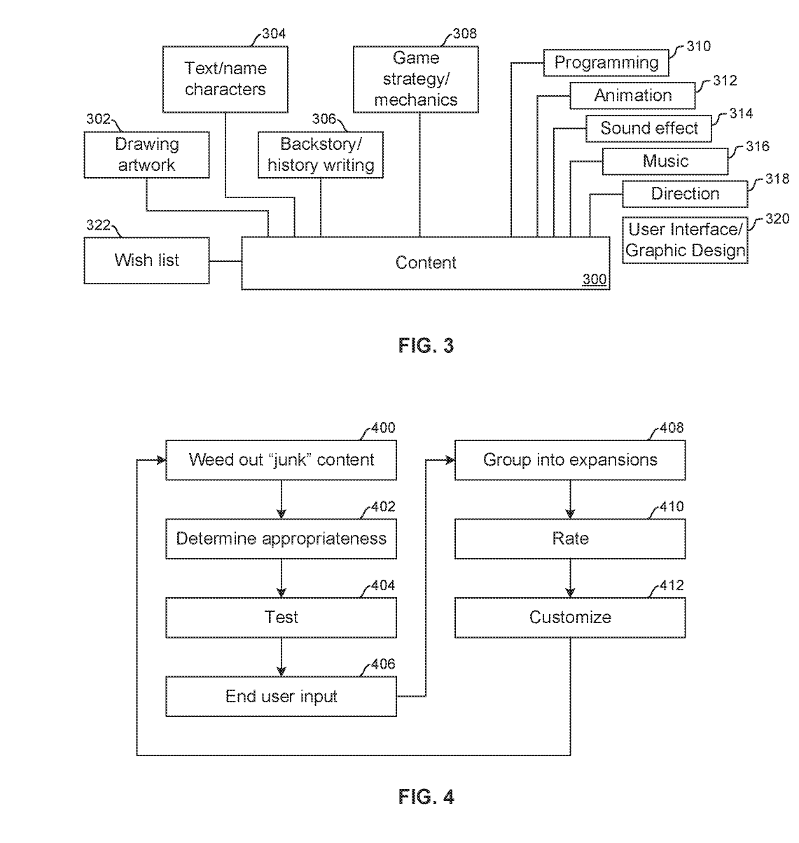

FIG. 3 illustrates further details of the contribution module 200. Examples of types of specialized work that can be added to content 300 include drawing artwork 302, writing text descriptions/naming characters 304, story writing/history or backstory creation 306, game mechanics including rules and strategy authoring 308, machine learning (sometimes referred to herein as artificial intelligence or “AI”) programming 310, animation 312, sound effects 314, music scoring, performing, recording, and mixing 316, and high level project direction 318 (vision, style, base story . . . ) Also, user interface (UI) and graphic design 320 may be types of specialized work as can be play testing, discussed further below in reference to FIG. 4. Such content may be referred to herein as “units” and “content pieces”.

Furthermore, wish lists 322 from end consumers can be received indicating content that customers would like to have added. This can be used by content creators as an inspiration in creating their content so that they make content that is more relevant and valued by the end users. Thus, for example, players can vote to rate content to steer content creators to work to finish works in progress that players are more excited about. This benefits the players as they are more likely to get new content that is of interest to them. This benefits the content creators as their work is more likely to be widely used, leading to their compensation being based on the fact that their work is in wider circulation.

Thus, FIG. 3 may include both content creation and content submission. In such a case, the wish list can be discussed in relation to both. Wish list items can be submitted in the submission step, and wish list items can be used as guidance and inspiration in the content creation step. Similar to the wish list, a content creator can browse things that still need to be done in projects that are in progress, such as “fill in flying aquatic monster here” in a map that still contains a place holder. Content creation can also include starting new projects and creating content that is incomplete, such as containing placeholders for things that need to be filled in During content curation, if a piece of content is submitted and associated with a particular wish list item, then the submitter of that wish list item can be given more influence when curating that content as the submitter would know how well it fits the wish list item.

Thus, the contribution module 200 brings together different content pieces for forming single pieces of content, or gathering multiple pieces of content into a set, such as a game expansion pack, where the pieces of content in the set fit together in some way such as thematically or game play balance wise. In an example, this may be accomplished by each contributor appending a content ID to each piece, with a single piece of content being correlated to a single content ID, such that all portions of the content are associated by a common content ID.

In this way, different portions of the content creation can be done in different orders. For example, for a new card in a trading card game, the game mechanics may be created before or after the title and flavor text for the card has been created. Similarly, the flavor text may be created before or after the artwork is drawn for the card. In a game level project, a map might be drawn indicating that certain types of things should go in particular locations and those things can be created later, while some existing things may be placed as the map is created. The content to fill in place holders in the map may have constraints or notes from the map creator that the content creators can use for inspiration and guidance as they create the things to fill those place holders.

FIG. 4 illustrates example details of the content curation/distribution module 202, which can instantiate a multi-level curation system for evaluating content, and controlling the bundling and distribution of content. It should be understood that FIG. 4 typically starts after a contributor has entered content into the system. It should be further understood that the levels in FIG. 4 do not necessarily follow the example shown and that some levels may be combined. Thus, for example, level 408 (“group into expansions”) may come before level 406 (“end user input”) and level 410 for rating content may be part of level 402 for determining the appropriateness of content, since rating of content desirably may occur before content is grouped into expansions. Some levels may be omitted entirely. For example, a content creator may create a model of a sword, including artwork and physics, to be added to a library of available content, but he might not include it as part of an expansion set as part of that workflow.

In greater detail, a first level 400 weeds out junk content and promotes content were people made a significant effort. This may be done by a human expert reviewing submitted content pieces and/or by artificial intelligence (AI). A second level 402 determines the appropriateness of the content for the environment in which it will be used. This may be genre-based. For example, for content intended to be used in a game, an editor may ensure that the style of created artwork is consistent with the range of artwork styles already in the game, or with the other pieces in the set. As a more detailed example, if a cartoon animated sword is proposed for a game with realistically rendered artwork, then that should get rejected as being out of character with existing game artwork that is more realistic than cartoonish, with the cartoon sword being retained in a database for use in a game where it would fit in stylistically. When content pieces are re-purposed in this manner, the content ID with which the content pieces are associated can be changed to the ID of the new content. Furthermore level 402 may also determine a rating for content, such as determining that a bloody zombie should have a rating indicating that it is not appropriate for younger audience members. This can ensure that the content will not get used in a composition that is targeted to younger audience members.

At a level 404, testing such as play testing of the content piece may be done. For example, for content to be added to a game play, adding the new content may be tested to ensure that adding the new piece preserves the balance of the game play. Block chains can be used to track the play testing and can be analyzed to determine the effects of adding the new content to the game. A consensus of input from curators can be used in level 404 to determine if the piece of content passes the testing.

This process of curation and approval of content can be used in creating sets of laws for governing things such as organizations.

At level 406 end users can have input into the content that is included in public distributions. In this way, curators can grow in influence as they gain experience, especially if their curation decisions tend to be in line with the eventual consensus. If inexperienced curators are curating a piece of content, then it might take a larger number of them to approve or disapprove that content.

At level 408 content can be grouped into expansions that are then evaluated and eventually distributed by curators as a group of content. For example, a level for a game can contain one or more maps along with numerous other items. Some of the items included in an expansion may be items that already exist. Potential groupings of content can be tested by artificial intelligence for game balance. The grouping of content into expansions may result in multiple potential groupings to be considered, in which later testing can determine which of those possibilities is most desirable.

At level 410 content can be rated based on its fit for different cultural values. For example, each content piece may be tagged with ratings indicating level of violence and level of sexual content. Such ratings can also be useful to ensure that inappropriate content does not get included in projects used by children.

The content that is created is agnostic to any game engine as much as possible. Customizations for particular game engines can be added as an end step at level 412 for content that will only be used for a particular purpose where the game engine will be known.

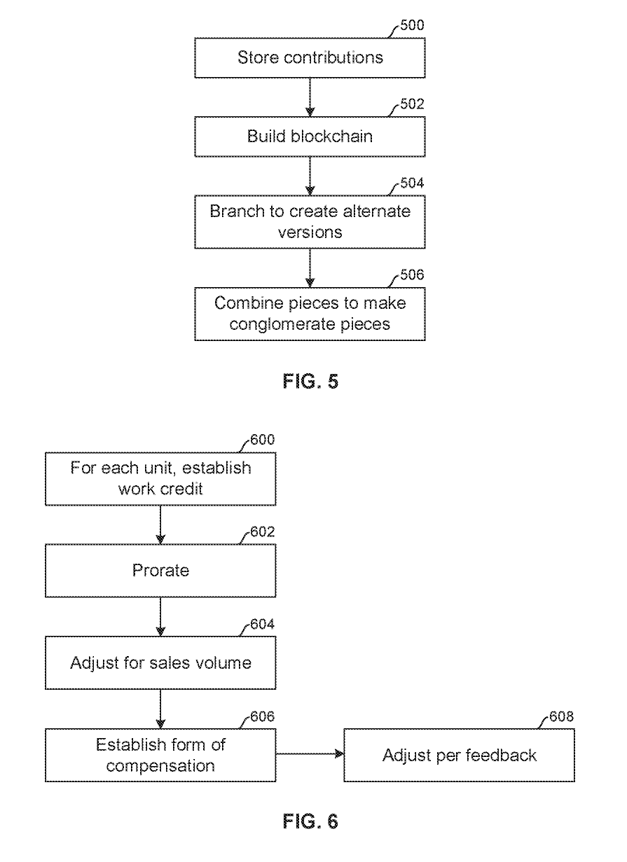

FIG. 5 illustrates details of an pie workflow/tracking module 204. At level 500 contributions are stored in a system that keeps an immutable history and allows branching. Each contributed content piece may be tagged with an ID of the content with which it is intended to be used, ratings, ID of creator, date of creation, etc. To this end, if desired at level 502 the contributed content pieces may be used with block chain technology for tracking contributions.

Level 504 indicates that content can be branched off to create alternate versions of the content. This may be done by a human expert or by a machine learning algorithm that, for example, learns what colors garners prefer (via customer feedback or popularity as indicated by game sales or other metric) for certain game pieces, etc. and then creating alternate content pieces with the alternate characteristics. Artificial intelligence can also analyze the rules around the content mathematically and adjust the rules so that mathematically they fit within the game, and potentially fill gaps where other game pieces do not already have the same mathematical fit.

Level 506 indicates that content elements can be combined to make conglomerate content elements. This allows good elements to be reused and for sets of content to have recurring themes. Content can be reused for multiple different projects. For example a 3D model of a teapot can be used in multiple different games where the presence of a teapot would be appropriate. In some cases, the same model will be used, but colored differently to fit in with each use.

FIG. 6 illustrates details of an example compensation for contributors module 206. This module tracks the contributions made by each user in creating and creating content, allocating to user's compensation based on the amount and/or value of work they put into the creation of content.

At level 600, creators are given work credit for the amount of effort they put into their respective units. Thus, more credit can be given to tasks that require more significant effort, such as the fact that it takes significantly more time to draw a piece of artwork than to curate that piece of artwork to approve it as not being junk.

In some implementations, the compensation can be based on feedback about the use of content after the sale or distribution of the content. Such collection of feedback should be done with the permission of the user, such as by incentivizing users to opt-in by providing them with credits or additional content. Accordingly, at level 602, the work credit is prorated to reflect the percent of the unit relative to the work on the final content that is published. Also, if desired at level 604 the total amount of credit for a piece of content (unit) is adjusted and can depend on the amount that the piece of content ends up getting used or on sales of the content. A creator who contributes to content that ends up being popular with end users would therefore be compensated more than another creator who contributed just as much to other content that did not get used much. Not only total sales may be used to this end, but also the number of times end users cumulatively clicked on or otherwise interacted with a particular piece of content. Shares of total compensation may be determined using AI or by bidding between end users.

Level 606 establishes the form of compensation to content creators. One or more forms may be used for any given individual creator. Compensation can be monetary to allow some content creators to spend a larger amount of their time creating content. Compensation can be in the form of credits for content to motivate creators for a game because they love the game. Level 608 adjusts compensation based on feedback on the use of the content to increase the portion of compensation to contributors of pieces that are favored or used more by end users.

As well, compensation can be in the form of prestige in the content creation and curation community. This can be as simple as giving status for bragging rights, to giving status that allows a creator more creative control. Compensation can be in the form of credits that give creators flexibility in the type of reward they get. For example, a credit can be exchanged for one dollar in cash, or it can be exchanged for a higher amount of credit towards purchasing content. In some implementations compensation may be in the form of attribution. The system may also allow a content creator to opt out of such attribution or commit content in an anonymous manner.

The system described above can be used to allow the addition of user generated content to a collectable unit game, such as a block chain powered game. Content can be added to a collectible unit game in the form of expansions that are assembled and play-tested through the curation process. When playing the game, players can decide on the set of expansions that will be allowed for that game session. In a block chain system, expansions can be implemented as additional chains that branch off of the main block chain. The expansion can be tracked through a separately maintained block chain. This allows people who do not play with the expansion to not have the overhead of the blocks that track the expansion when dealing with the block chain, minimizing the size of the block chain data needed for the base game. In a block chain system, expansions could be added to the set of possibilities in the main branch, but flagged to indicate that they are part of a particular expansion. When a new unit is added to the game, the user that owns that new unit (through mining or being awarded for maintaining new blocks in the chain) may be given the choice if he would like for the new unit to be from the base set or from the expansion set. When a new unit is added, the new unit may come either from the base set or the expansion set in a deterministic manner to account for the rarities of each unit within each set as well as the relative rarity between the base set and the expansion set. The relative rarity between the base set and the expansion set may change over time, such as the expansion cards becoming less likely over time, or the expansion set becoming less likely in proportion to the trading volume of the expansion set, or becoming more or less likely as it is voted up or down by a consensus of active users. Regardless of how the block chain is maintained, a unit in one set can be exchanged for a unit in another set by creating two transactions that are signed by both parties, one transferring the first unit and the other transferring the second unit. When all units are tracked in the same block chain, the transactions can be stored in the same block, or in some implementations both unit transfers can be made in the same signed transaction. This will reduce the amount of work to ensure that both transfers occur as a single atomic transaction. A system can allow units of one set to be traded for units of another set. Such an exchange would only involve a single user acting within the established rules for established trades. The established rules can take into account the rarities of each unit and/or the differential in desirability between the two sets. In some cases, the rules may indicate that the number of units being traded does not equal the number of units received for the trade.

In some instances, the players of the game can act as curators by placing offers to trade units for newly proposed units. If a large enough consensus of players places such trade offers then the proposed unit can pass a hurdle to becoming an official unit. Systems can be put in place to ensure that such proposed units would not disrupt the balance of gameplay. For example, if a unit was proposed that had the same functionality as an existing unit, but with additional benefits, then many players would want to trade for that unit since it is out of balance with existing units. The curation of the addition of an expansion set should ensure that there is adequate play testing to ensure that the game play balance is maintained by the addition of the expansion.

A unit can be a placeholder fora class of units such that when a player goes to play with such a unit he will have to pick which option from the class of units the unit will be in the course of that game play. For example, a unit can be a light quick strike vehicle, but within that class or unit the player will have choices in how that unit is equipped, such as an option that has more fire power and less armor, or an option that has more armor and less fire power. The choice made for that unit can be different the next game that the player uses the unit in.

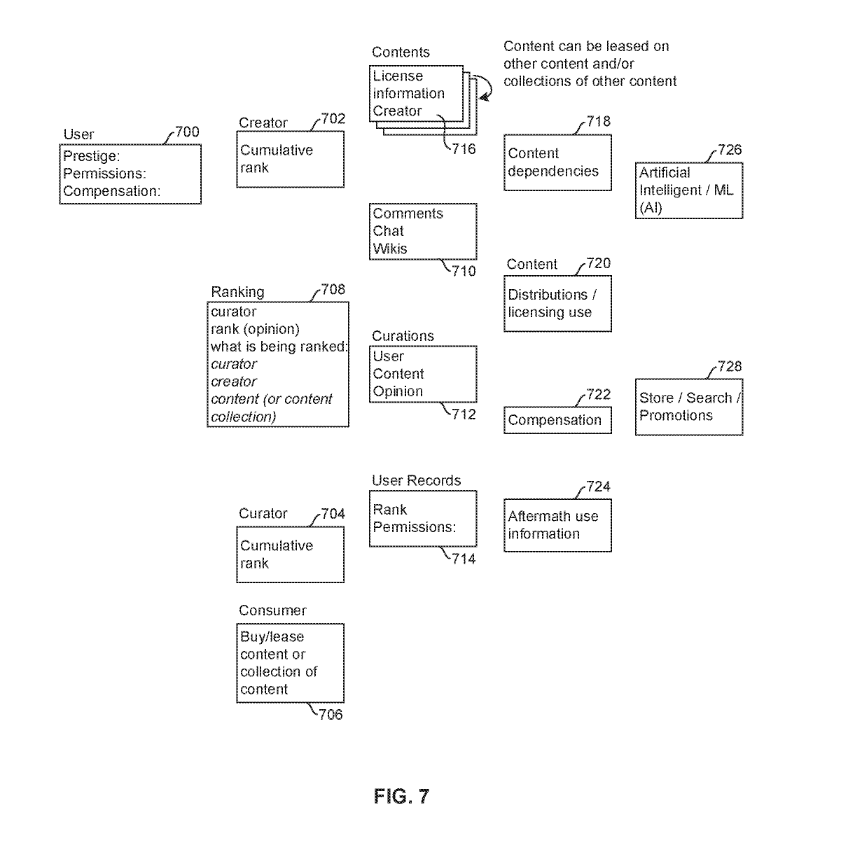

Now referring to FIG. 7, various of the above-discussed module elements are illustrated, it being understood that all of the elements shown in FIG. 7 may be communicatively to each other and/or through a system server.

Users 700 may be associated with respective characteristics including prestige, permissions, and compensation. Furthermore, users who are creators 702 may be associated with respective ranks among other creators. Likewise, curators 704 may be associated with respective ranks among other curators and/or creators. Consumers 706 buy or lease content or collections of content. In some instances, content may be provided to consumers for free.

Rankings 708 may be provided for each curator, creator, and content (or content collection). Rankings typically may be derived from end user feedback, sales volume, and other indications of acceptance. For example, rankings may be derived from user comments, chat, and wikis 710. Curations 712 may indicate the user/creators, the content, and opinions of end users. User records 714 may indicate, for each user, his or her rank and permissions the user is entitled to, such as subscriptions. Curations can include input, such as voting or numeric ratings, about content by users of the system entitled to give such feedback on the content.

Contents 716 including individual content pieces (units) typically include information regarding content licenses, and the creator(s) of the content. Content dependencies 718 may also be stored. Content records 720 may include information regarding distribution of the content and licensing use requirements. Compensation records 722 typically are maintained consistent with above principles, as is aftermath use information 724 such as end user ratings, sales volume, etc. for each content and/or unit (piece of content). One or more AI engines 726 may be employed consistent with principles herein. Store, search, and promotion information 728 also is maintained for access.

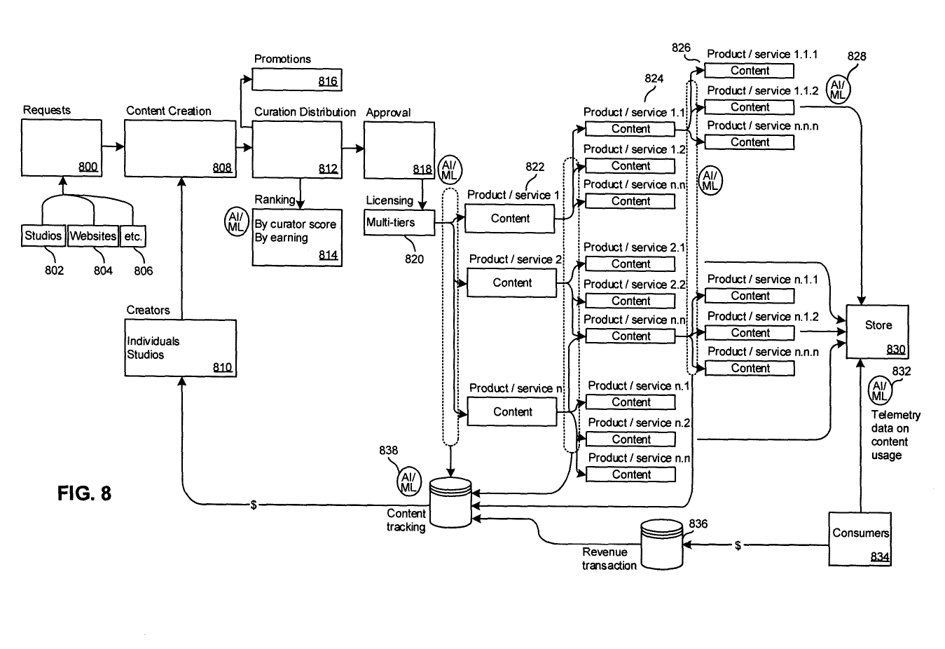

FIG. 8 illustrates an example process flow consistent with principles above. Requests 80 for content may be received from studios 802, websites 804, and other sources 806 for content creation 808. Creators of content may be individual contractors or employees of companies such as studios 810. Content is curated and distributed 812 with curators being awarded scores and/or earnings (monetary compensation) 814. The rankings may be determined using machine learning (AI) according to principles discussed above. Promotions 816 may be generated and distributed to promote the content being distributed.

Content distribution approval 818 may be granted after review by end distributors and then licensed for, if desired, multi-tier distribution 820. The tiers may include multiple top tiers 822 such as major retailers, with each top tier 822 potentially having plural middle tiers 824 and each middle tier 824 potentially having plural lowest tiers 826. More than three distribution tiers may be used. AI 828 may be used to determine end user distribution.

Once distributed, content typically is stored in various data stores 830 until accessed by consumers 834 for consumption. All 832 may be used to acquire and analyze telemetry data on content usage as discussed above in reference to FIG. 7 to determine the popularity or success of individual content titles including by analyzing revenue transactions 836. Content distributed in the multi-tier distribution chain 820 is correlated with the revenue transaction 836 in content tracking 838 for apportionment of the revenue to content creators and curators as described above.

It may now be appreciated that in some implementations the system is a standardized system that is used to generate content that is used in multiple game titles. A growing library of reusable content can be created through such a system. Such a library would allow standard items such as a bucket, shovel, or hat to be reused many times without needing to be recreated each time it is used. In some implementations content created by the system is used in existing video games. In some implementations, the content created by the system includes complete video games. Such complete video games may allow other user generated content, which may be

In some implementations content curation involves play testing content to ensure that all of the content preserves the balance of power in a game. Such play testing can be in the form of playing a game with the addition of new units being curated to see how well those units fit within the game. Such play testing can be in the form of playing a complete game being curated to ensure that the game is balanced. Such play testing can find bugs in content. Content curators can provide feedback about their findings in a variety of ways, depending on the design of the system, including adding comments associated with content, participating in wilds, forums, or other discussions, voting on content, such as an approval or rejection, or filing a ticket or bug report when problems are found. Such play testing can also test the user interface (UI) to determine factors such as how easy it is to use and how attractive it is to the user. Curators can provide feedback about their opinions of the graphic design of content. Some information about the UI can be generated automatically through records of the user's interaction with the UI. For example, if users play testing a particular UI tend to click on several other game items first and take a long time to find a particular menu item then the system can indicate that the menu item might be located in a place that is not intuitive to find. Artificial intelligence (AI) used to analyze data captured during play testing can be more sophisticated such that it can do things such as create a new version of the content with corrections made where weakness in the design or game play imbalances are detected.

As mentioned above, the curation system may be used for creating laws governing things such as organizations. Curating the laws for an online club through the system would be almost identical to creating the set of rules governing game play.

In some implementations, the system includes AI that can create content based on minimal guidance. In some cases, the AI may create large numbers of potential game rules or game unit strength combinations and execute extensive virtual play testing to determine which units are viable game units. In some cases, the AI may use requests from users as guidance in creating new content. In some cases, users can provide descriptions, such as “dragon with blue wings” for that an AI generated image should be an image of. In some cases, users can provide examples of images that are in the style that they wish and the AI will create an image in a similar style. For example, if a user requested that the AI produce an image of a “dragon with blue wings” and gave example images that were mostly dark with splashes of vibrant color then the AI could determine what dragons look like, draw a dragon following the style learned from the example images, and use blue for the coloration when drawing the wings. The AI can use other content in the system for examples of what a dragon looks like. Any content that the AI uses to base its work on can be tracked to allow the content that the AI uses as a basis to be compensated when the AI content is used. The requester that spawned the AI may also be compensated when the AI generated content she inspired is used.

In some implementations AI can be used to perform play testing. Since AI can run a large quantity of virtual games in a short amount of time it can be very good at finding corner cases in the rules that traditional play testing might miss. AI can start a game and branch that game into multiple games as decision points or random branches occur. This can allow the AI to generate a tree of game play paths that more thoroughly cover the possibilities. This can be good for finding situations such as ambiguities or conflicts in rules, or cases where the rules do not work well together and game play balance is off for that corner case. The AI may also identify changes to the game rules and then play test the new version of the rules that it came up with.

AI play testing can be done on a user's game system if the user agrees to run it. The user can be compensated, including being granted new game units, for the use of their computing power. A large installed base of game units can provide the computing power to do a lot of play testing. A game can use system computing power for play testing possible rules for a new expansion to the game when players of the game are in a portion of the game that does not require much computing power. This allows the expansion of the game to be well polished when it is released, benefiting players of the game whose computing power was used for the AI, running play testing AI can be used as a form of mining for new game content by users to reward them for the computing power that they expend running the AI.

As discussed above, a piece of content curated through the system can be part of multiple different expansion sets for one or more games, and would be included when any of those expansions are used. The content may also be used on its own in one or more games. The base content can be more popular or be ranked higher when browsing content, the more compositions the content is included in and/or the more times the content or compositions including the content is used.

In some implementations content curators can form an arbitration panel, which can settle disputes and provide final decisions for things such as what content is gathered together into a collection such as an expansion.

In some implementations, the games that use content from the content curation system provide feedback to the content curation system about the use and/or desirability of content from the system within the game. The content creation system can use this information in determining compensation for content creators. This information can also be used in promoting content and ranking content in search results so that popular and more desirable content is easier to find in the system. In some implementations, the information about use of content can be used to detect and/or stop unauthorized use of content.

By selling enough units, either stand alone or part of larger content compositions, a content creator can make enough money to be able to spend more of his time creating content, even becoming a professional content creator if the system is widely used.

In some implementations, content creators can be compensated with ownership of newly generated game units as their content is makes it through the curation process and is added to the system and/or as their content is sold or used. These units allow the content creator to play with those units in one or more games. These units can also be sold, traded, or gifted by the content creator, just like any owned game units, which can provide for a source of income for the content creator. In some implementations, the awarded game units correspond with the content created by the content creator, such as being units created by the content creator, or being an expansion set containing content created by the content creator In some implementations, the game units do not correspond with the content created by the content creator, such as awarding game units from the latest expansion in a game the content creator enjoys playing.

In some implementations, the system provides a way for users to request content when a search does not return content that was searched for. In some instances, these requests may reference content. This is useful in cases where the referenced content can be used as a basis or portion of the desired content if the existing content could be used with a modification or if the desired content is a conglomerate that can include the referenced content. The referenced content can also be referred to as examples of features that are desired or not desired. Content creators can use the requests for content to guide their content creation as a means of artistic inspiration and as a way of increasing the likelihood that the content that they are creating fulfills a need and is likely to get used.

As divulged previously, in some implementations the content system contains content built for a particular standardized physics engine. In some implementations, the content system contains content that can be used with more than one physics engine. In some cases, the content system provides the capability to translate the physics of content its collection to be usable for a particular physics engine. The base content in the system can be written for a particular standardized physics engine or can be written in a portable physics definition format.

In some implementations, the system host makes a share of the proceeds from selling content, which will encourage more people to set up system hosts.

Discussion above relates that the system may have content ratings to allow people to not have to wade through content that is not appropriate for their audience to find the content they are looking for. The system is useful for designing content for a massively multi-player online game. In such a system, many of the players of the game would be interested in creating content to appear in the game, which will lead to a very rich game environment.

It will be appreciated that whilst present principals have been described with reference to some example embodiments, these are not intended to be limiting, and that various alternative arrangements may be used to implement the subject matter claimed herein.

What is claimed is:

1. A system, comprising:
a processor-implemented contribution module to which creators make types of contributions to content depending on their strengths and interests;
a processor-implemented content curation and distribution module for evaluating content from the contribution module and controlling bundling and distribution of content;
a processor-implemented workflow/tracking module that facilitates branching and combining content from the content curation and distribution module; and
a processor-implemented compensation module that tracks contributions to the contribution module made by each creator and determines compensation based on an amount and/or perceived quality or worth of work each creator puts into creating the content.

2. The system of claim 1, wherein the content comprises a computer game.

3. The system of claim 1, wherein the contribution module comprises input for receiving contributions in at least three of: drawing artwork, writing text descriptions/naming characters, story writing/history or backstory creation, game mechanics including rules and strategy authoring, software programming, animation, sound effects, music scoring, performing, recording, and mixing, user interface (UI) design, graphics design, and high-level project direction.

4. The system of claim 3, wherein the contribution module comprises a map indicating that certain types of first content pieces should go in particular locations of a final content product and those first content pieces are created later, while existing second content pieces are placed in the final content product as the map is created.

5. The system of claim 1, wherein the content curation and distribution module comprises a sub-module to weed out first content and promote second content.

6. The system of claim 1, wherein the content curation and distribution module comprises a sub-module to determine appropriateness of content pieces for an environment in which the content pieces are sought to be used.

7. The system of claim 6, wherein the second sub-module is configured to ensure that a style of artwork is consistent with a range of artwork styles already in a computer game.

8. The system of claim 1, wherein the content curation and distribution module comprises a sub-module for testing of content pieces made by creators as contributions to content.

9. The system of claim 1, wherein the content curation and distribution module comprises a sub-module to receive end user input into content that is included in public distributions.

10. The system of claim 1, wherein the content curation and distribution module comprises a sub-module to group content pieces, made by creators as contributions to content, into expansions that are evaluated and distributed by curators as a group of content.

11. The system of claim 1, wherein the content curation and distribution module comprises a sub-module to rate content pieces, made by creators as contributions to content, based on fitness for cultural values.

12. . The system of claim 11 wherein content from the contribution module is agnostic to any game engine, and the content curation and distribution module comprises a sub-module to customize content for particular game engines.

13. The system of claim 1, wherein the content curation and distribution module comprises a sub-module to receive input from consumers regarding content that consumers desire to have.

14. The system of claim 1, wherein the workflow/tracking module comprises a first sub-module to store content from the contribution module and maintain a process history and allow branching.

15. The system of claim 14, wherein the workflow/tracking; module uses block chain technology for tracking contributions.

16. The system of claim 14, wherein the workflow/tracking module comprises a second sub-module to facilitate branching of content to create alternate versions of the content

17. A system comprising:
a processor-implemented compensation module that tracks contributions of content pieces made by plural creators and determines compensation based on an amount and/or perceived quality or worth of work each creator puts into creating the content pieces, the compensation module comprising:
a first sub-module to accord creators work credit for the amount of effort they put into their respective content pieces;
a second sub-module to prorate the work credit to reflect a percent of the content piece relative to the work on final content that is published;
a third sub-module to adjust total amount of credit for a piece of content based on an amount that the piece of content is used in the final content; and
a fourth sub-module to establish a form of compensation to content creators.

18. The system of claim 17, wherein forms of compensation comprise monetary remuneration, credits to receive content, prestige awards.

19. A method comprising:
receiving requests from plural sources for content creation;
creating content based on the requests;
curating and distributing the content in a multi-tier distribution chain;
storing the content to allow access to the content by consumers for consumption;
determining popularity or success of individual content titles; and
based on the popularity of success of individual content titles, remunerating creators of content pieces in the individual content titles.

20. The method of claim 19, comprising correlating content distributed in the multi-tier distribution chain with the revenue transactions for the content to apportion revenue to content creators and curators.
